(19) United States
(12) Patent Application Publication
(10) Pub. No.: US 2015/0298402 A1
(43) Pub. Date: Oct. 22, 2015

(54) Carbon fiber composite material boom, production method thereof and truck-mounted concrete pump comprising the carbon fiber composite material boom

(71) Applicant: ZOOMLION HEAVY INDUSTRY SCIENCE AND TECHNOLOGY CO., LTD., Hunan (CN)

(72) Inventors: Xiaochao LI, Hunan (CN); Jiaqian WANG, Hunan (CN); Shu LI, Hunan (CN)

(73) Assignee: ZOOMLION HEAVY INDUSTRY INDUSTRY SCIENCE AND TECHNOLGY CO.,LTD., Hunan (CN)

(21) Appl. No.: 14/345,402

(22) PCT Filed: Dec. 4, 2012
(86) PCT No.: PCT/CN2012/085833

§ 371 Date: Mar. 17, 2014

(30) Foreign Application Priority Data
Jul. 5, 2012 (CN) 201210232251.3

(51) Int. Cl. B29C 70/34; B29C 70/44; F16L 9/12; E04G 21/04

(52) U.S. Cl. CPC B29C 70/342; E04G 21/0445; B29C 70/443; F16L 9/123; B29K 2105/0872

(57) ABSTRACT

The present invention discloses a carbon fiber composite material boom, a production method thereof, and a truck-mounted concrete pump comprising the carbon fiber composite material boom. The production method of the carbon fiber composite material boom comprises: a flexible airbag is inflated to form an airbag in a first state and a carbon fiber prepreg is laid on the outer surface of the airbag in the first state to obtain a first transitional component; the first transitional component is put into a box-shaped mold and the airbag in the first state is inflated; the carbon fiber prepreg is compressed and shaped to obtain a second transitional component; the second transitional component is heated up and solidified, and cooled and de-molded after being solidified to obtain the carbon fiber boom.

### TECHNICAL FIELD OF THE INVENTION

The present invention relates to the field of concrete pumping, and more particularly to a carbon fiber composite material boom, a production method thereof, and a truck-mounted concrete pump comprising the carbon fiber composite material boom.

### BACKGROUND OF THE INVENTION

Currently, more and more concrete conveyance is completed by truck-mounted concrete pumps. Truck-mounted concrete pumps are experiencing a huge change and developing into extra-long lightweight ones. While the design level of truck-mounted concrete pumps has become increasingly high nowadays, great breakthrough can be hardly realized to lighten truck-mounted pump trucks only from the perspective of structural design.

As research continues, technicians find the following disadvantages existing in traditional truck-mounted pumps:

(1) the used steel materials are relatively high in density and relatively heavy in weight, thus the truck-mounted pumps can be hardly lightened;

(2) traditional steel booms are welded by high strength steel plates with poor welding performance. In addition, the service lives of the booms are shortened and construction safety is affected easily because the seams are cracked easily due to the poor welding performance of the high strength steel plates;

(3) high strength steel booms are easily ruptured due to fatigue because of the relatively low fatigue resistance of traditional high strength steel, which is hard to satisfy requirements of lightweight truck-mounted pumps with extra-long booms;

(4) the poor corrosion resistance of the steel booms further influences the service lives of the booms.

In the face of so many disadvantages of existing steel materials themselves, it will become the major breakthrough to replace the current widely-applied steel materials with a novel material with light weight and high strength to realize extra-long lightweight truck-mounted pump products.

In recent years, thanks to the advantages of light weight, high strength, high modulus, corrosion resistance, good designability etc., high-performance carbon fiber resin-based composite materials, which can satisfy requirements including light weight, fatigue resistance and high strength etc. of truck-mounted concrete pumps, are used as boom materials.

Taking the Chinese patent application No. 201010524104.4 for example, a method for manufacturing a carbon fiber composite material boom for a truck-mounted concrete pump is disclosed. In the specific disclosure, a core mold which is a hollow structure is provided. A raw material for manufacturing the carbon fiber boom is laid on the outer surface of the core mold. A vacuum film is coated outside the raw material. The two ends of the vacuum film which is provided with a bleeder hole are sealed at the two ends of the core mold. The whole mold is placed into an autoclave, pressurized by compressed air, and heated up, solidified and shaped by an electric heating pipe.

In the shaping method above, the used equipment cost and machining cost are relatively high, which is not beneficial to large-scale promotion. Therefore, it is of great significance to develop a method for manufacturing a composite material boom of truck-mounted concrete pump with low cost.

### SUMMARY OF THE INVENTION

The purpose of the present invention is to overcome the disadvantages of the prior art and provide a method for producing a carbon fiber composite material boom, and a carbon fiber composite material boom and a truck-mounted concrete pump produced by the method to reduce the equipment cost and the production cost.

Therefore, a method for producing a carbon fiber composite material boom is provided in the present invention, comprising the following steps: S1: preliminary shaping: a flexible airbag is inflated to form an airbag in a first state and a carbon fiber prepreg is laid on the outer surface of the airbag in the first state to obtain a first transitional component; S2: compression shaping: the first transitional component is placed in a box-shaped mold and the airbag in the first state is inflated to form an airbag in a second state; the carbon fiber prepreg is compressed and shaped to obtain a second transitional component; S3: solidification and shaping: the second transitional component is heated up and solidified, and cooled and de-molded after being solidified to obtain the carbon fiber boom.

Further, S2 further comprises the following steps: S21: first compression shaping: the first transitional component is put into a vacuum bag and sealed, the vacuum bag is vacuumized, and compression shaping is performed for the carbon fiber prepreg in the vacuumized vacuum bag for the first time to obtain an intermediate transitional component; S22: secondary compression shaping: the intermediate transitional component is put into the box-shaped mold and the air bag in the first state is inflated to form the airbag in the second state; compression shaping is performed for the carbon fiber prepreg for a second time to obtain the second transitional component.

Further, the gas pressure in the airbag in the first state in S1 is 0.1 MPa to 0.3 MPa, the vacuum bag is vacuumized to −0.1 MPa to −0.07 MPa in S21, and the gas pressure in the airbag in the second state in S22 is 0.6 MPa to 0.8 MPa.

Further, a step of performing thermal shrinkage for the second transitional component is further included before the heating up and solidifying processing in S3, and the step of performing thermal shrinkage comprises: heat and pressure preservation is performed for the second transitional component at 40□ to 70□ for 30 to 60 minutes.

Further, the step of heating up and solidifying the second transitional component in S3 comprises: heat preservation is performed for the second transitional component at 100□ to 180□ for 2 to 8 hours.

Further, the step of heating up and solidifying the second transitional component in S3 comprises: S41: first solidification: the second transitional component is heated up to 100□ to 120□ slowly and subjected to heat preservation for 1 to 2 hours; S42: secondary solidification: the second transitional component having undergone the first solidification is heated up to 150□ to 180□ slowly and subjected to heat preservation for 2 to 3 hours.

Further, S1 further comprises: S11: a release agent is sprayed and coated on the outer surface of the airbag in the first state; S12: the carbon fiber prepreg is laid on the outer surface of the airbag in the first state, wherein the outer surface is sprayed and coated with the release agent.

Further, S1 further comprises: S13: release cloth, a perforated isolating membrane and a ventilated felt are respectively laid on the outer surface of the carbon fiber prepreg laid on the outer surface of the airbag in the first state to form the first transitional component.

Further, the process of laying the carbon fiber prepreg on the outer surface of the airbag in the first state in S1 further comprises: a metal connector is embedded in a certain position of the carbon fiber boom formed by the carbon fiber prepreg.

Further, the juncture of the metal connector and the solidified carbon fiber prepreg is coated with an adhesive after the cooling and de-molding in S3 and the carbon fiber boom is obtained after the adhesive is dried.

The present invention further provides a carbon fiber composite material boom, wherein the carbon fiber composite material boom is prepared according to the above method.

The present invention further provides a truck-mounted concrete pump in which a boom is provided, wherein the boom is the above carbon fiber composite material boom.

The present invention has the following beneficial effect: the carbon fiber prepreg is structured more compactly through shaping for multiple times in the production method of the carbon fiber composite material boom provided by the present invention, which is beneficial to the production of a carbon fiber composite material boom with excellent performance. The production method of the carbon fiber boom only uses simple equipment comprising the flexible air bag, the box-shaped mold and an oven to produce the carbon fiber boom without an autoclave, thereby reducing the equipment cost and the production cost.

Besides the above-mentioned purposes, features and advantages, the present invention has other purposes, features and advantages. The present invention will be explained in details below with reference to the drawings.

### BRIEF DESCRIPTION OF THE DRAWINGS

The accompany drawings, which form one part of the specification and are used for further understanding the present invention, show preferred embodiments of the present invention and are used for describing the principle of the present invention with the specification. In the drawings:

FIG. 1 is a schematic diagram illustrating a section view of a carbon fiber composite material boom according to an embodiment of the present invention.

### DETAILED DESCRIPTION OF THE INVENTION

The technical solution in the embodiments of the present invention will be described in details below in combination with the accompanying drawings in the embodiments of the present invention. However, the following embodiments and accompanying drawings are only used for understanding the present invention, but cannot limit the present invention. The present invention may be implemented in various different ways defined and covered by the claims.

The term “prepreg” in the present invention refers to a prepreg formed by mixing and impregnating a fiber material with a weight content of 50% to 70% and a resin material with a weight content of 30% to 50%, wherein the fiber material comprises, but is not limited by one of carbon fibers and aramid fibers etc. or combinations of multiple fibers; the resin material comprises, but is not limited by epoxy resins, unsaturated resins and phenol formaldehyde resins. The “carbon fiber prepreg” used in the present invention can be produced by a method in the prior art.

In a typical embodiment of the present invention, a method for producing a carbon fiber composite material boom comprises the following steps: S1: preliminary shaping: a flexible airbag is inflated to form an airbag in a first state and a carbon fiber prepreg is laid on the outer surface of the airbag in the first state to obtain a first transitional component; S2: compression shaping: an intermediate transitional component is placed in a box-shaped mold and the airbag in the first state is further inflated to form an airbag in a second state; compression shaping is performed for a second time to obtain a second transitional component; S3: solidification and shaping: the second transitional component is heated up and solidified, and cooled and de-molded after being solidified to obtain the carbon fiber composite material boom.

In the method for producing the carbon fiber composite material boom, in the step of preliminary shaping, carbon fiber prepregs with moderate thicknesses may be laid according to the force conditions of different portions of the boom. In addition, the prepregs may be laminated according to different directions to improve the mechanical properties of the boom, e.g. the carbon fiber prepregs are cut into strips, one strip is laid in the axial direction of the air bag in the first state and then one strip is laid along the airbag in the first state to arrange the carbon fiber prepregs in a staggered manner on the outer surface of the airbag in the first state. Such a preliminary shaping method is highly-adjustable, which is beneficial to improve the mechanical properties of the formed boom.

In the method for producing the carbon fiber composite material boom, the box-shaped mold with a fixed structure is introduced into the step of compression shaping and the flexible airbag is inflated for a second time based on the fixed structure of the box-shaped mold. During the secondary inflation, the outer surface of the airbag presses the carbon fiber prepreg towards the direction of the inner surface of the box-shaped mold, so that the carbon fiber prepreg is structured more compactly.

In the method for producing the carbon fiber composite material boom, the flexible airbag is used in conjunction with the box-shaped mold, which simplifies the production process of the carbon fiber composite material boom, avoids the use of an autoclave, and reduces the equipment cost and the production cost.

In a preferred embodiment of the present invention, the process of compression shaping in S2 of the method for producing the carbon fiber composite material boom comprises the following steps: S21: first compression shaping: the first transitional component is put into a vacuum bag and sealed, the vacuum bag is vacuumized, and compression shaping is performed for the carbon fiber prepreg in the vacuumized vacuum bag for the first time to obtain the intermediate transitional component; S22: secondary compression shaping: the intermediate transitional component is put into the box-shaped mold and the air bag in the first state is further inflated to form an airbag in a second state; compression shaping is performed for the carbon fiber prepreg for a second time to obtain the second transitional component.

The compression step in the method for producing the carbon fiber composite material boom is divided into two steps. A step of using the vacuum bag is used before using the box-shaped mold. The step utilizes the fixed structure of the airbag in the first state and the vacuum bag is reduced gradually by vacuumizing. In addition, the carbon fiber prepreg is pressed towards the direction of the airbag in the first state so that the carbon fiber prepreg is structured more compactly, and the carbon fiber prepreg is aggregated on the outer surface of the airbag in the first state. On this basis, the box-shaped mold with a fixed structure will be further introduced, and the flexible airbag may be inflated for a second time based on the fixed structure of the box-shaped mold. During the secondary inflation, the outer surface of the airbag has been pressed by the carbon fiber prepreg aggregated by the vacuum bag towards the direction of the inner surface of the box-shaped mold so that the carbon fiber prepreg is structured more compactly.

In the method for producing the carbon fiber composite material boom, the gas pressure in the airbag in the first state, the gas pressure in the airbag in the second state and the vacuumizing pressure of the vacuum bag can be determined according to practical applications. In a preferred embodiment of the present invention, the gas pressure in the airbag in the first state in S1 in the method for producing the carbon fiber boom is 0.2 MPa to 0.4 MPa, the vacuum bag is vacuumized to −0.1 MPa to −0.07 MPa in S21, and the gas pressure in the airbag in the second state in S22 is 0.6 MPa to 0.8 MPa. In the pressure ranges above, the prepreg can be laminated stably while being compacted.

In order to further reinforce the strength of the carbon fiber composite material boom prepared by the present invention, a step of thermal shrinkage is performed for the second transitional component preferably before the heating up and solidifying processing in S4 in the method for producing the carbon fiber composite material boom. The step of thermal shrinkage comprises: heat and pressure preservation is performed for the second transitional component at 40° C. to 70° C. for 30 to 60 minutes. In this process, the temperature is increased to 40° C. to 70° C. to preheat the carbon fiber prepreg so that the viscosity of a resin mixed in the carbon fiber prepreg is reduced appropriately to separate air bubbles in the resin from the carbon fiber prepreg. At the same time, the gas in the airbag in the second state undergoes thermal expansion after the increase of the temperature and presses the carbon fiber prepreg outwards to eliminate the air bubbles in the carbon fiber prepreg to further compact the structure of the carbon fiber prepreg, which is beneficial to improve the strength of the produced carbon fiber composite material boom.

The required solidifying temperature may be analyzed reasonably according to the type of the applied resin in the step of heating up and solidifying the second transitional component in S4 in the method for producing the carbon fiber composite material boom. In a preferred embodiment of the present invention, the step of heating up and solidifying the second transitional component in S4 comprises: heat preservation is performed for the second transitional component at 100° C. to 180° C. for 2 to 8 hours.

Preferably, the step of heating up and solidifying the second transitional component in S4 comprises: S41: first solidification, and S42: secondary solidification. S41: first solidification comprises: the second transitional component is heated up to 100° C. to 120° C. slowly and subjected to heat preservation for 1 to 2 hours; S42: secondary solidification comprises: the second transitional component having undergone the first solidification is heated up to 150° C. to 180° C. slowly and subjected to heat preservation for 2 to 3 hours. In this process, the carbon fiber prepreg in the second transitional component is heated up and solidified twice. During the first solidification, the temperature is controlled at 100° C. to 120° C., which is beneficial to solidify the carbon fiber prepreg uniformly and controllably and reduce unbalanced internal stress of the prepared carbon fiber composite material boom caused by non-uniform solidification, while reducing air bubbles or implosion caused by solidification heat. During the second solidification, the temperature is controlled at 150° C. to 180° C. to further promote crosslinking and solidification of the resin to obtain a relatively high crosslinking density, so as to further improve the strength of the prepared carbon fiber composite material boom. In order to complete the cooling and de-molding processing after the solidification in the method for producing the carbon fiber composite material boom,

Preferably, S1 further comprises: S11: a release agent is sprayed and coated on the outer surface of the airbag in the first state; S12: the carbon fiber prepreg is laid on the outer surface of the airbag in the first state, wherein the outer surface is sprayed and coated with the release agent. The applied release agent can use a common release agent on the market, and those skilled in the art are able to select the type of the release agent reasonably, which will not be repeated here.

In order to better perform the vacuumizing processing in the process of performing the first compression shaping in the method for producing the carbon fiber composite material boom, preferably, S1 further comprises: S13: release cloth, a perforated isolating membrane and a ventilated felt are respectively laid on the outer surface of the carbon fiber prepreg laid on the outer surface of the airbag in the first state to form the first transitional component. The perforated isolating membrane is set to form an appropriate distance between the vacuum bag and the carbon fiber prepreg to prevent the carbon fiber prepreg from blocking the bleeder hole of the vacuum bag during vacuumizing, which is beneficial to implement the vacuumizing processing successfully. The ventilated felt is set to separate the perforated isolating membrane and the vacuum bag. The air holes in the ventilated felt further facilitate flowing of the vacuumized gas. The release cloth is set to separate the perforated isolating membrane and the carbon fiber prepreg during the process of the cooling and de-molding processing.

To facilitate application of the carbon fiber composite material boom prepared by the method for producing the carbon fiber composite material boom, preferably, the process of laying the carbon fiber prepreg the outer surface of the airbag in the first state in S1 further comprises: a metal connector is embedded in a certain position of the carbon fiber boom formed by the carbon fiber prepreg. The metal connector is embedded in the carbon fiber prepreg, which not only omits a step of installing the metal connector on the carbon fiber composite material boom, but also is beneficial to shape the metal connector and the carbon fiber composite material boom integrally. Defect points at the juncture can be reduced and the connection stability can be improved to further prolong the service life and improve the safety performance of the carbon fiber composite material boom.

To better improve the connection stability of the metal connector and the carbon fiber composite material boom, preferably, the juncture of the metal connector and the solidified carbon fiber prepreg is coated with an adhesive after the cooling and de-molding in S4 and the carbon fiber boom is obtained after the adhesive is dried. The juncture of the metal connector and the solidified carbon fiber prepreg is coated with the adhesive to avoid electrochemical corrosion to the metal parts and improve the service life and safety performance of the boom.

During practical operation, the used adhesive can apply a commercial product, preferably a high toughness adhesive. Those skilled in the art are able to analyze the selection of the adhesive reasonably, which will not be repeated here.

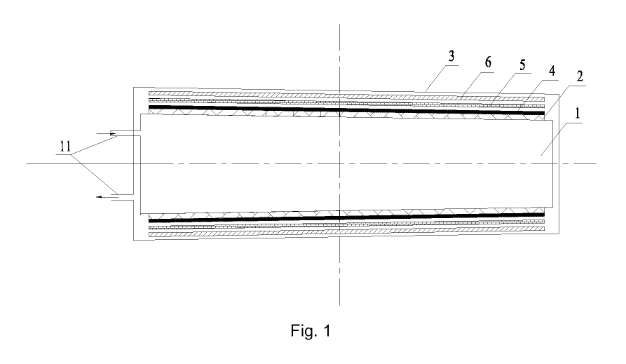

As shown in FIG. 1, in a specific embodiment of the present invention, an airbag in a first state is formed by inflating a flexible airbag 1 through an air charge and discharge port 11 of the flexible airbag 1. A release agent is sprayed and coated on the outer surface of the airbag in the first state. A carbon fiber prepreg 2 is laid on the outer surface of the airbag in the first state, wherein the outer surface of the airbag in the first state is sprayed and coated with the release agent, and a metal connector is embedded in a certain position of a carbon fiber composite material boom formed by the carbon fiber prepreg. Release cloth 4, a perforated isolating membrane 5 and a ventilated felt 6 are respectively laid on the outer surface of the carbon fiber prepreg 2 to form a first transitional component. The first transitional component is put into a vacuum bag 3 and sealed. The vacuum bag 3 is vacuumized, and compression shaping is performed for the carbon fiber prepreg under the interaction between the vacuumized vacuum bag 3 and the airbag in the first state to obtain an intermediate transitional component. The intermediate transitional component is put into a cylindrical mold, and the airbag in the first state is further inflated to form an airbag in a second state. Under the interaction between the airbag in the second state and a box-shaped mold, compression shaping is performed for the carbon fiber prepreg for a second time to obtain a second transitional component. The second transitional component is heated up and solidified, and cooled and de-molded after being solidified. The juncture of the metal connector and the solidified carbon fiber prepreg is coated with an adhesive and the carbon fiber boom is obtained after the adhesive is dried.

The carbon fiber composite material boom provided by the method above makes full use of the advantage that the carbon fiber composite material has a strength similar to that of steel, but has a density which is only ¼ of that of steel to ensure the high strength and safety of the boom while reducing the boom weight by more than 40%, which is beneficial to produce a long boom. At the same time, the carbon fiber composite material boom provided by the method above makes full use of the advantages of high specific strength, high specific modulus, corrosion resistance, fatigue resistance and excellent designability of the carbon fiber composite material to improve the carbon fiber composite material boom performances in all aspects. In addition, the equipment cost and machining cost are greatly reduced by reasonable setting methods. Moreover, the carbon fiber composite material boom is provided with good fatigue resistance and corrosion resistance as well as good damping property, which reduces vibration of the boom and improves the usability and safety performance of a truck-mounted pump.

A truck-mounted concrete pump provided with the carbon fiber composite material boom can be developed into an ultra-long lightweight truck-mounted concrete pump.

The beneficial effect of the present invention will be further described below according to the specific embodiments.

### Embodiment 1

Carbon fiber prepreg: a fiber material T300 carbon fiber with a weight content of 70%, which is produced by Japanese company Toray, and a resin matrix having a weight content of 30% and mainly comprising AG-80 epoxy resin produced by Shanghai Research Institute of Synthetic Resins.

Production Method:

An airbag in a first state and an internal pressure of 0.3 MPa is formed by inflating a flexible airbag 1 through an air charge and discharge port 11 of the flexible airbag 1 first. A carbon fiber prepreg 2 is laid on the outer surface of the airbag in the first state to form a first transitional component. The first transitional component is put into a vacuum bag 3 and sealed, and the vacuum bag 3 is vacuumized to an internal pressure of −0.1 MPa. Compression shaping is performed for the carbon fiber prepreg for the first time under the interaction of the vacuumized vacuum bag 3 and the airbag in the first state to obtain an intermediate transitional component. The intermediate transitional component is put into a cylindrical mold, and the airbag in the first state is further inflated to form an airbag in a second state and an internal pressure of 0.6 MPa. Under the interaction between the airbag in the second state and the cylindrical mold, compression shaping is performed for the carbon fiber prepreg for a second time to obtain a second transitional component. The second transitional component is put into an oven, heated up to 40° C. slowly, subjected to pressure preservation for 70 minutes, slowly heated up to 100° C., solidified for the first time, subjected to pressure preservation for 1 hour, further heated up to 150° C., solidified for a second time, subjected to pressure preservation for 3 hours, and cooled and de-molded after being solidified, and a carbon fiber composite material boom is obtained after a drying process.

### Embodiment 2

Carbon fiber prepreg: a fiber material T700 carbon fiber with a weight content of 50%, which is produced by Japanese company Toray, and a resin matrix having a weight content of 50% and mainly comprising E-51 epoxy resin produced by Wuxi Resin Factory of Bluestar New Chemical Materials Co., Ltd.

Production Method:

An airbag in a first state and an internal pressure of 0.2 MPa is formed by inflating a flexible airbag 1 through an air charge and discharge port 11 of the flexible airbag 1 first. A WB-411 type release agent produced by AXEL Company is sprayed and coated on the outer surface of the airbag in the first state. A carbon fiber prepreg 2 is laid on the outer surface of the airbag in the first state, wherein the outer surface of the airbag in the first state is sprayed and coated with the release agent. A first transitional component is put into a vacuum bag 3 and sealed, and the vacuum bag 3 is vacuumized to an internal pressure of −0.07 MPa. Compression shaping is performed for the carbon fiber prepreg for the first time under the interaction of the vacuumized vacuum bag 3 and the airbag in the first state to obtain an intermediate transitional component. The intermediate transitional component is put into a cylindrical mold, and the airbag in the first state is further inflated to form an airbag in a second state and an internal pressure of 0.8 MPa. Under the interaction between the airbag in the second state and the cylindrical mold, compression shaping is performed for the carbon fiber prepreg for a second time to obtain a second transitional component. The second transitional component is put into an oven, heated up to 50° C. slowly, subjected to pressure preservation for 60 minutes, slowly heated up to 100° C., solidified for the first time, subjected to pressure preservation for 2 hours, further heated to 150° C., solidified for a second time, subjected to pressure preservation for 3 hours, solidified for a second time, and cooled and de-molded after being solidified to obtain a carbon fiber boom.

### Embodiment 3

Carbon fiber prepreg: a fiber material T700 carbon fiber with a weight content of 60%, which is produced by Japanese company Toray, and a resin matrix having a weight content of 40% and mainly comprising MTM82 phenol formaldehyde resin produced by ACG Company.

Production Method:

An airbag in a first state and an internal pressure of 0.4 MPa is formed by inflating a flexible airbag 1 through an air charge and discharge port 11 of the flexible airbag 1 first. A release agent is sprayed and coated on the outer surface of the airbag in the first state. A prepreg 2 is laid on the outer surface of the airbag in the first state, wherein the outer surface of the airbag in the first state is sprayed and coated with the release agent. Release cloth 4, a perforated isolating membrane 5 and a ventilated felt 6 are respectively laid on the outer surface of the prepreg 2 to form a first transitional component. The first transitional component is put into a vacuum bag 3 and sealed, and the vacuum bag 3 is vacuumized to an internal pressure of −0.085 MPa. Compression shaping is performed for the prepreg for the first time under the interaction of the vacuumized vacuum bag 3 and the airbag in the first state to obtain an intermediate transitional component. The intermediate transitional component is put into a cylindrical mold, and the airbag in the first state is further inflated to form an airbag in a second state and an internal pressure of 0.7 MPa. Under the interaction between the airbag in the second state and the cylindrical mold, compression shaping is performed for the prepreg for a second time to obtain a second transitional component. The second transitional component is put into an oven, heated up to 40° C. slowly, subjected to pressure preservation for 60 minutes, subjected to thermal shrinkage processing, further heated up to 120° C. slowly and solidified, subjected to heat preservation for 1 hour, further heated up to 180° C. and solidified for a second time, subjected to heat preservation for 2 hours, and cooled and de-molded after being solidified to obtain a boom.

### Embodiment 4

Carbon fiber prepreg: a fiber material T700 carbon fiber with a weight content of 50%, which is produced by Japanese company Toray, and a resin matrix having a weight content of 50% and mainly comprising WH-2000 type epoxy resin produced by Shanghai Yikang Chemicals & Industries Co., Ltd.

Production Method:

An airbag in a first state and an internal pressure of 0.3 MPa is formed by inflating a flexible airbag 1 through an air charge and discharge port 11 of the flexible airbag 1 first. A release agent is sprayed and coated on the outer surface of the airbag in the first state. A carbon fiber prepreg 2 is laid on the outer surface of the airbag in the first state, wherein the outer surface of the airbag in the first state is sprayed and coated with the release agent. In addition, a metal connector is embedded in a certain position of a carbon fiber boom formed by the carbon fiber prepreg. Release cloth 4, a perforated isolating membrane 5 and a ventilated felt 6 are respectively laid on the outer surface of the carbon fiber prepreg 2 to form a first transitional component. The first transitional component is put into a vacuum bag 3 and sealed, and the vacuum bag 3 is vacuumized to an internal pressure of −0.08 MPa. Compression shaping is performed for the carbon fiber prepreg for the first time under the interaction of the vacuumized vacuum bag 3 and the airbag in the first state to obtain an intermediate transitional component. The intermediate transitional component is put into a cylindrical mold, and the airbag in the first state is further inflated to form an airbag in a second state and an internal pressure of 0.7 MPa. Under the interaction between the airbag in the second state and the cylindrical mold, compression shaping is performed for the carbon fiber prepreg for a second time to obtain a second transitional component. The second transitional component is put into an oven, heated up to 70° C. slowly, subjected to pressure preservation for 40 minutes, subjected to thermal shrinkage processing, slowly heated up to 110° C. and solidified, subjected to heat preservation for 1.5 hours, further heated up to 165° C. and solidified for a second time, subjected to heat preservation for 2.5 hours, and cooled and de-molded after being solidified, and an Adadite 2011 type adhesive produced by Beijing Innova Composites Technology Co., Ltd. is coated at the juncture of the metal connector and the solidified carbon fiber prepreg to obtain the carbon fiber boom.

### Comparison Example 1

Carbon fiber prepreg: the same as that in the first embodiment

Production method: prepared by applying a method in Chinese patent application No. 201010524104.4 and the method is described as follows:

The carbon fiber prepreg is laid on the outer surface of a core mold and a vacuum film is coated outside the carbon fiber prepreg. The two ends of the vacuum film which is provided with a bleeder hole are sealed at the two ends of the core mold. The whole mold is placed into an autoclave, pressurized by compressed air, and heated up, solidified and shaped by an electric heating pipe.

The performances in all aspects of the carbon fiber booms prepared from the first embodiment to the fourth embodiment and the carbon fiber boom prepared in the first comparison example are tested, and the test results are as shown in Table 1.

TABLE 1

| | Embodiment 1 | Embodiment 2 | Embodiment 3 | Embodiment 4 | Comparison example 1 |
|---|---|---|---|---|---|
| Density | About | About | About | About | 1.6 g/cm³ |
| | 1.62 g/cm³ | 1.5 g/cm³ | 1.56 g/cm³ | 1.5 g/cm³ | |
| Corrosion | Excellent | Excellent | Excellent | Excellent | Excellent |
| resistance | | | | | |
| Service life | About 10 | About 10 | About 10 | About 10 | About 10 years |
| | years | years | years | years | |
| Production | About 350 | About 300 | About 330 | About 290 | About 500 thousand/ton |
| cost | thousand/ton | thousand/ton | thousand/ton | thousand/ton | |

It can be learned from the data in Table 1 that the performances in all aspects of the carbon fiber booms prepared from the first embodiment to the fourth embodiment are similar to the performances in all aspects of the carbon fiber boom prepared in the first comparison file. However, the production costs are reduced, and the preparation process only utilizes simple devices, comprising a flexible airbag, a box-shaped mold and an oven to produce a carbon fiber boom without an autoclave, thereby reducing the equipment cost and the production cost.

The production method of the carbon fiber composite material boom provided by the present invention is not only applicable to carbon fiber prepregs, but also applicable to prepregs of other materials, e.g. glass fiber prepregs and basalt fibers etc., all of which belong to the protection scope of the present invention.

The above are only preferred embodiments of the present invention and are not used for limiting the present invention. For those skilled in the art, the invention may have various modifications and changes. Any modifications, equivalent replacements and improvements etc. made within the spirit and principle of the present invention should be contained within the protection scope of the present invention.

1. A production method of a carbon fiber composite material boom, wherein it comprises the following steps:
S1: preliminary shaping: inflating a flexible airbag to form an airbag in a first state and laying a carbon fiber prepreg on an outer surface of the airbag in the first state to obtain a first transitional component;
S2: compression shaping: putting the first transitional component into a box-shaped mold and inflating the airbag in the first state to form an airbag in a second state; compressing and shaping the carbon fiber prepreg to obtain a second transitional component;
S3: solidification and shaping: heating up and solidifying the second transitional component, and cooling and de-molding after solidifying to obtain a carbon fiber boom.

2. The production method of the carbon fiber composite material boom according to claim 1, wherein S2 further comprises the following steps:
S21: first compression shaping: putting the first transitional component into a vacuum bag and sealing the vacuum bag, vacuumizing the vacuum bag, and compression shaping the carbon fiber prepreg in the vacuumized vacuum bag for the first time to obtain an intermediate transitional component;
S22: secondary compression shaping: putting the intermediate transitional component into a box-shaped mold and inflating the air bag in the first state to form the airbag in the second state; compression shaping the carbon fiber prepreg for a second time to obtain the second transitional component.

3. The production method of the carbon fiber composite material boom according to claim 2, wherein a gas pressure in the airbag in the first state in S1 is 0.1 MPa to 0.3 MPa, the vacuum bag is vacuumized to −0.1 MPa to −0.07 MPa in S21, and a gas pressure in the airbag in the second state in S22 is 0.6 MPa to 0.8 MPa.

4. The production method of the carbon fiber composite material boom according to claim 1, wherein a step of performing thermal shrinkage for the second transitional component is further comprised before the heating up and solidifying processing in S3, and the step of performing thermal shrinkage comprises:
performing heat and pressure preservation for the second transitional component at 40° C. to 70° C. for 30 to 60 minutes.

5. The production method of the carbon fiber composite material boom according to claim 4, wherein the step of heating up and solidifying the second transitional component in S3 comprises: performing heat preservation for the second transitional component at 100° C. to 180° C. for 2 to 8 hours.

6. The production method of the carbon fiber composite material boom according to claim 5, wherein the step of heating up and solidifying the second transitional component in S3 comprises:
S41: first solidification: heating up the second transitional component to 100° C. to 120° C. slowly and performing heat preservation for 1 to 2 hours;
S42: secondary solidification: heating up the second transitional component having undergone the first solidification to 150° C. to 180° C. slowly and performing heat preservation for 2 to 3 hours.

7. The production method of the carbon fiber composite material boom according to claim 1, wherein S1 further comprises:
S11: spraying and coating a release agent on the outer surface of the airbag in the first state;
S12: laying the carbon fiber prepreg on the outer surface of the airbag in the first state, wherein the outer surface is sprayed and coated with the release agent.

8. The production method of the carbon fiber composite material boom according to claim 7, wherein S1 further comprises:
S13: laying release cloth, a perforated isolating membrane and a ventilated felt in sequence on the outer surface of the carbon fiber prepreg laid on the outer surface of the airbag in the first state to form the first transitional component.

9. The production method of the carbon fiber composite material boom according to claim 1, wherein the process of laying the carbon fiber prepreg on the outer surface of the airbag in the first state in S1 further comprises: embedding a metal connector in a certain position of the carbon fiber boom formed by the carbon fiber prepreg.

10. The production method of the carbon fiber composite material boom according to claim 9, wherein coating a juncture of the metal connector and the solidified carbon fiber prepreg with an adhesive after the cooling and de-molding in S3 and obtaining the carbon fiber boom after the adhesive is dried.

11. A carbon fiber composite material boom, wherein the carbon fiber composite material boom is prepared according to the method of claim 1.

12. A truck-mounted concrete pump in which a boom is provided, wherein the boom is the carbon fiber composite material boom according to claim 11.

13. The production method of the carbon fiber composite material boom according to claim 2, wherein S1 further comprises:
S11: spraying and coating a release agent on the outer surface of the airbag in the first state;
S12: laying the carbon fiber prepreg on the outer surface of the airbag in the first state, wherein the outer surface is sprayed and coated with the release agent.

14. The production method of the carbon fiber composite material boom according to claim 4, wherein S1 further comprises:
S11: spraying and coating a release agent on the outer surface of the airbag in the first state;
S12: laying the carbon fiber prepreg on the outer surface of the airbag in the first state, wherein the outer surface is sprayed and coated with the release agent.

15. The production method of the carbon fiber composite material boom according to claim 5, wherein S1 further comprises:
S11: spraying and coating a release agent on the outer surface of the airbag in the first state;
S12: laying the carbon fiber prepreg on the outer surface of the airbag in the first state, wherein the outer surface is sprayed and coated with the release agent.

16. The production method of the carbon fiber composite material boom according to claim 6, wherein S1 further comprises:
S11: spraying and coating a release agent on the outer surface of the airbag in the first state;
S12: laying the carbon fiber prepreg on the outer surface of the airbag in the first state, wherein the outer surface is sprayed and coated with the release agent.

17. The production method of the carbon fiber composite material boom according to claim 2, wherein the process of laying the carbon fiber prepreg on the outer surface of the airbag in the first state in S1 further comprises: embedding a metal connector in a certain position of the carbon fiber boom formed by the carbon fiber prepreg.

18. The production method of the carbon fiber composite material boom according to claim 4, wherein the process of laying the carbon fiber prepreg on the outer surface of the airbag in the first state in S1 further comprises: embedding a metal connector in a certain position of the carbon fiber boom formed by the carbon fiber prepreg.

19. The production method of the carbon fiber composite material boom according to claim 6, wherein the process of laying the carbon fiber prepreg on the outer surface of the airbag in the first state in S1 further comprises: embedding a metal connector in a certain position of the carbon fiber boom formed by the carbon fiber prepreg.
